(19) United States
(12) Patent Application Publication
(10) Pub. No.: US 2026/0212235 A1
(43) Pub. Date: Jul. 23, 2026

(54) INFERENCE MANAGEMENT FOR A MOBILE MULTI-USER COMPUTING ENVIRONMENT

(71) Applicant: INTERNATIONAL BUSINESS MACHINES CORPORATION, Armonk, NY (US)

(72) Inventors: Francis Powlesland, München (DE); Alecio Pedro Delazari Binotto, Munich (DE); Fernando Luiz Koch, Palm Beach Gardens, FL (US)

(21) Appl. No.: 19/035,365

(22) Filed: Jan. 23, 2025

(51) Int. Cl. G06N 5/046; G06Q 50/40

(52) U.S. Cl. CPC G06N 5/046; G06Q 50/40

(57) ABSTRACT

Inference management for a mobile, multi-user computing environment includes receiving sensor data from a plurality of sensors in the mobile computing environment and passenger data from a plurality of passenger devices within the mobile computing environment. Context information is generated from the sensor data and the passenger data. A plurality of artificial intelligence (AI) models are stored locally within the mobile computing environment. Each AI model has a model profile specifying attributes of the AI model. The context information is compared with the model profiles of the AI models. Different ones of the plurality of AI models are dynamically activated and deactivated for performing inference tasks in a local computing system within the mobile computing environment in real time based on matching the context information with the model profiles.

### BACKGROUND

This disclosure relates to managing and/or orchestrating activation and use of machine learning models for performing inference in a multi-user, mobile computing environment.

There are many different situations in which computer systems respond to demands for content from multiple users. Such situations arise in large venues such as sporting events, convention centers, transportation hubs such as airports, railway stations, bus stations, as well as certain mobile computing environments. An example of a mobile computing environment is a multi-passenger vehicle such as an automobile, a commercial aircraft (e.g., a plane and/or jet airplane), a bus, a train, or the like. In each of these environments, users often consume significant quantities of content whether the content is instructional, safety related, or for purposes entertainment. Providing this content requires significant computational resources for both playback and delivery to the devices used by the end users.

In the typical case, the content provided to users in these environments is largely static in nature. That is, the content requested and played is premade or pre-generated. For example, the content may be pre-made movies or television shows, pre-recorded songs, books, and the like. More and more users, however, are consuming dynamically generated content. Dynamically generated content refers to content that is created or generated using generative artificial intelligence (AI) technology. The generation and delivery of this type of content requires even greater computational resources than delivering static content. When mobile computing environments are considered, the challenges of providing dynamically generated content to users within such environments become even greater.

### SUMMARY

In one or more embodiments, a method includes receiving sensor data from a plurality of sensors in a mobile computing environment and passenger data from a plurality of passenger devices within the mobile computing environment. The method includes generating context information from the sensor data and the passenger data. The method includes storing a plurality of artificial intelligence (AI) models locally within the mobile computing environment. Each AI model has a model profile specifying attributes of the AI model. The method includes comparing the context information with the model profiles of the AI models. The method includes dynamically activating and deactivating different ones of the plurality of AI models for performing inference tasks in a local computing system within the mobile computing environment in real time based on matching the context information with the model profiles.

In one or more embodiments, a computer system includes a processor set, one or more computer-readable storage media, and program instructions stored on the one or more computer-readable storage media to cause the processor set to perform the various operations described within this disclosure.

In one or more embodiments, a computer program product includes one or more computer-readable storage media and program instructions stored on the one or more computer-readable storage media to perform the various operations described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates a computing environment in accordance with one or more embodiments of the disclosed technology.

FIG. 2 illustrates certain operative features of a mobile computing environment in accordance with one or more embodiments of the disclosed technology.

FIG. 3 illustrates an example of an inference management system (IMS) in accordance with one or more embodiments of the disclosed technology.

FIG. 4 illustrates a method of AI model deployment performed by an IMS in accordance with one or more embodiments of the disclosed technology.

FIG. 5 illustrates a method of workload balancing as performed by an IMS in accordance with one or more embodiments of the disclosed technology.

FIG. 6 illustrates a method of context aware content delivery as performed by an IMS in accordance with one or more embodiments of the disclosed technology.

FIG. 7 illustrates another method of operation for an IMS in accordance with one or more embodiments of the disclosed technology.

### DESCRIPTION

While the disclosure concludes with claims defining novel features, it is believed that the various features described within this disclosure will be better understood from a consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to managing and/or orchestrating activation and use of machine learning models for performing inference in a multi-user, mobile computing environment. A mobile computing environment is disclosed that includes a computer system coupled to one or more sensors. The sensors may be distributed throughout the computing environment and are capable of detecting or measuring conditions in and/or around the mobile computing environment. The sensors, for example, may be capable of measuring or detecting information such as passenger density within the mobile computing environment, temperature within the mobile computing environment, and/or ambient lighting. The sensor data that is generated specifies a particular context that may be specified in terms of the various conditions detected by the sensors and/or indicated by the sensor data. The computer system of the mobile computing environment is capable of dynamically adjusting onboard services in real time based on the sensor data, which may be collected and/or analyzed continuously.

According to an aspect of the inventive arrangements, methods, systems, and computer-program products are provided that are capable of receiving sensor data from a plurality of sensors in a mobile computing environment and passenger data from a plurality of passenger devices within the mobile computing environment. Context information from the sensor data and the passenger data is generated. A plurality of artificial intelligence (AI) models are stored locally within the mobile computing environment. Each AI model has a model profile stored therewith that specifies attributes of the AI model. The context information is compared with the model profiles of the AI models. Different ones of the plurality of AI models are dynamically activated and deactivated for performing inference tasks in a local computing system within the mobile computing environment in real time based on matching the context information with the model profiles.

The inventive arrangements provide a technical effect in that those AI models that are most suited and capable of performing inference tasks, based on the current context of the mobile computing environment, are activated. Those not deemed suitable are deactivated. This conserves computing resources locally within the mobile computing environment and ensures that sufficient computing resources are available for the inference tasks that are to be performed or are expected to be performed given the current context. Further, the inventive arrangements provide the technical effect of adapting and responding over time in real time to changing contextual information.

In another aspect, the sensor data includes a sensor-based passenger density that is matched to passenger density ratings of the plurality of AI models. The passenger density ratings may be specified as a parameter of the respective model profiles. The inventive arrangements provide a technical effect in that the ability to adapt to changing context information in real time accounts for, or responds to, changing passenger densities in the mobile computing environment. Passenger density may be a ratio or other measure of passengers currently onboard the mobile computing environment compared to a total number of passengers (e.g., total capacity) that the mobile computing environment is capable of carrying or is rated to carry.

In some aspects, each AI model of the plurality of AI models having a passenger density rating (e.g., of the model profiles) exceeding a threshold passenger density is trained to perform a first set of one or more inference tasks. Further, each AI model of the plurality of AI models having a passenger density rating at or below the threshold passenger density is trained to perform a second set of one or more inference tasks. The inventive arrangements provide a technical effect in that only those particular AI models that are locally available are considered for activation and the activation is predicated on a matching or correspondence between the model profiles and the current context information. Thus, those AI models that are not relevant or considered useful given the current context are not activated and do not consume computational resources at the expense of other more useful AI models.

In some aspects, the first set of one or more inference tasks includes generating crowd management information within the mobile computing environment. The inventive arrangements provide a technical effect in that AI models that are capable of performing crowd management related inference tasks may be selected for activation over others that are not. This allows the system to more effectively manage which AI models are activated at any given time based on the current context, which may include peak times and/or times of high passenger density.

In some aspects, the first set of one or more inference tasks includes managing an onboard lighting system of the mobile computing environment. The inventive arrangements provide a technical effect in that AI models that are capable of performing particular inference tasks considered to be of greater significant such as controlling lighting within the mobile computing environment may be selected for activation over others that are not or that provide inference tasks deemed less significant or less critical. This allows the system to prioritize inference tasks relating to the ongoing management of the mobile computing environment over others that may be targeted or suited to content generation for passengers.

In some aspects, the first set of one or more inference tasks includes managing an onboard climate control system of the mobile computing environment. The inventive arrangements provide a technical effect in that AI models that are capable of performing particular inference tasks considered to be of greater significance such as climate control may be selected for activation over others that are not or that provide inference tasks deemed less significant or less critical. This allows the system to prioritize inference tasks relating to the ongoing management of the mobile computing environment over others that may be targeted or suited to content generation for passengers.

In some aspects, at least a first AI model of the plurality of AI models is activated that has a passenger density rating specified in the model profile that matches the sensor-based passenger density. Further, at least a second AI model of the plurality of AI models having a passenger density rating specified in the model profile that does not match the sensor-based passenger density is deactivated. The inventive arrangements provide a technical effect in that current context of the mobile computing environment is continually matched with suitable AI models of a plurality of available AI models that may be executed locally. This ensures that inference tasks are relevant to the current context, useful to passengers, and prevents consumption of computing resources by AI models that are not relevant and/or not significant or important given the current context information.

In another aspect, one or more first AI models of the plurality of AI models having a passenger density rating specified in the model profile that matches the sensor-based passenger density may be activated. One or more second AI models of the plurality of AI models having a passenger density rating specified by the model profile that does not match the sensor-based passenger density to a remote computing node may be offloaded. The inventive arrangements provide a technical effect in that AI models not deemed relevant or useful given a current context may be offloaded to another remote computing node thereby freeing local computing resources for AI models deemed more relevant or suitable to the current context information. Further, the offloading allows services provided to passengers by such AI models to continue rather than be discontinued albeit from a remote computing node.

In some aspects, the offloading is performed responsive to detecting that a network latency between the mobile computing environment and the remote computing node is below a threshold network latency. The inventive arrangements provide a technical effect in that the offloading may be constrained or limited to occur only in situations in which network conditions are favorable enough to ensure that any remotely performed inference tasks will still be provided in a timely manner for passengers. In cases where network latency is above a threshold, for example, where the user experience may be significantly degraded, the offloading may not be performed.

In some aspects, the offloading is performed responsive to determining that a complexity metric specified by the model profile of the at least a second AI model exceeds a threshold complexity. The inventive arrangements provide a technical effect in that for AI models that have a complexity metric indicating that inference tasks performed by the AI model consume significant computing resources, such AI models may be offloaded to a remote computing node. This allows the local computing resources to be used to execute other AI models including AI models that more closely match the current context information.

Further aspects of the embodiments described within this disclosure are described in greater detail with reference to the figures below. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

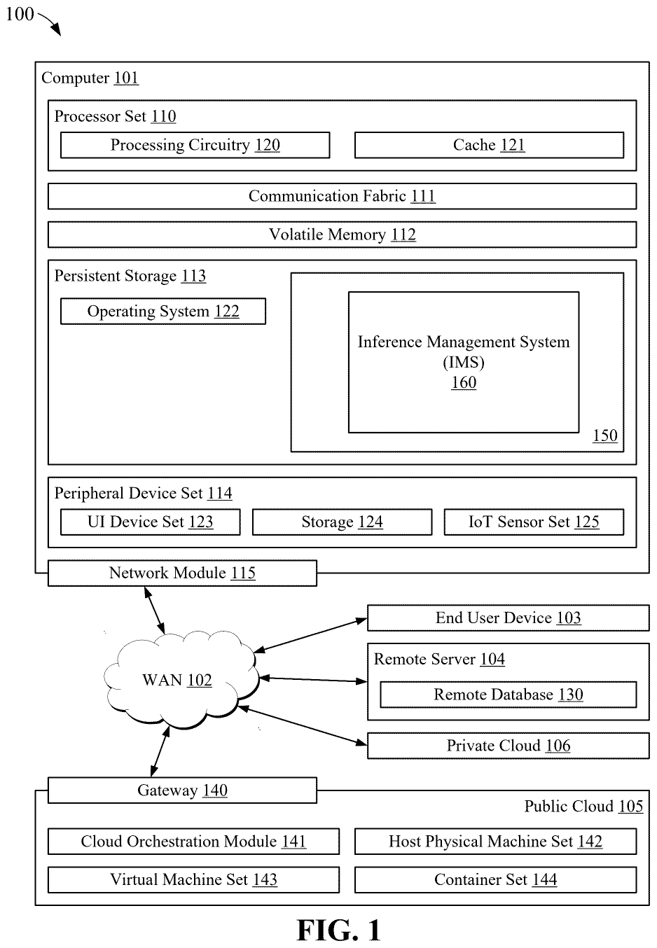

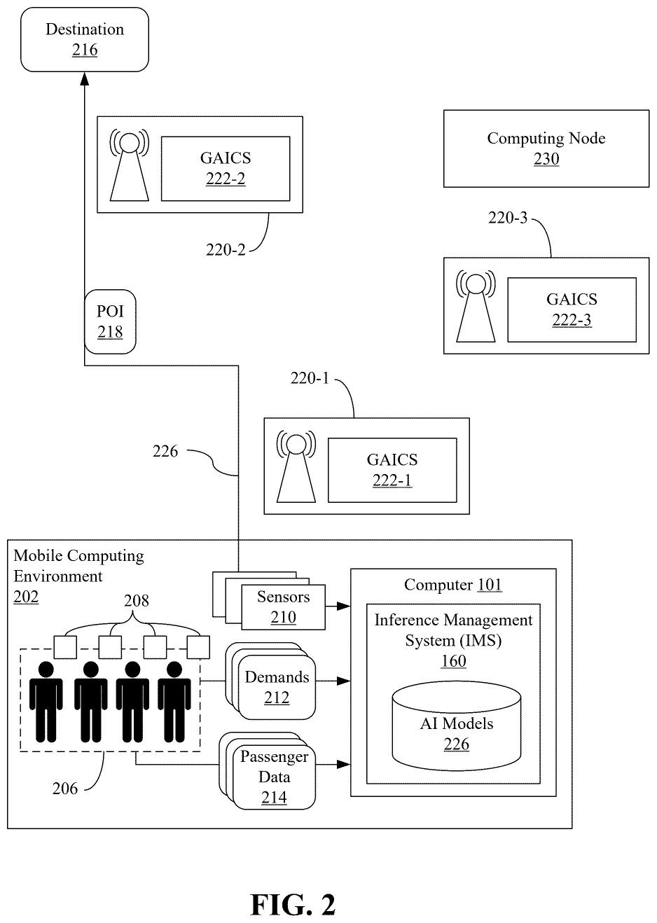

FIG. 1 illustrates a computing environment 100 in accordance with one or more embodiments of the disclosed technology. Computing environment 100 contains an example of an environment for the execution of at least some of the computer code in block 150 involved in performing the inventive methods. Block 150, for example, includes program code that is executable to perform methods relating to inference management for a mobile, multi-user computing environment. As illustrated, block 150 includes program code that implements an Inference Management System (IMS) 160. IMS 160, in executing within a suitable computing system such as computer 101, may be included in a mobile computing environment 202 as described herein in connection with FIG. 2.

In general, IMS 160 is capable of receiving sensor data from a plurality of sensors in mobile computing environment 202 and passenger data from a plurality of passenger devices within mobile computing environment 202. IMS 160 is capable of generating context information from the sensor data and the passenger data. IMS 160 is capable of storing a plurality of AI models locally within mobile computing environment 202, where each AI model has a model profile specifying attributes of the AI model. IMS 160 is capable of comparing the context information with the model profiles of the AI models. IMS 160 is also capable of dynamically activating and deactivating different ones of the plurality of AI models for performing inference tasks in a local computing system, e.g., computer 101, disposed or located within mobile computing environment 202 in real time based on matching the context information with the model profiles.

In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (e.g., a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

FIG. 2 illustrates certain operative features of mobile computing environment 202 in accordance with one or more embodiments of the disclosed technology. Mobile computing environment 202 may be implemented as a multi-passenger vehicle. Examples of multi-passenger vehicles may include, but are not limited to, an automobile, a truck, a van, a bus, an aircraft such as a helicopter, an airplane, a jet airplane, an orbital/space vehicle, trolley, a train, cable car, or the like. The mobile computing environment may include multiple different cars, compartments, or spaces in which passengers and/or users are able to sit, stand, or otherwise occupy. Mobile computing environment 202 may be a personally owned vehicle, a privately owned vehicle, or a public (e.g., public transit) vehicle.

In the example, mobile computing environment 202 may include computing resources illustrated as computer 101. It should be appreciated that the computing resources may be implemented as a plurality of interconnected, e.g., networked or coupled, computer systems. For purposes of illustration, the computing resources are illustrated as computer 101 executing IMS 160. In any case, computer 101 is an example of local computing resources of mobile computing environment 202 in that computer 101 is located or disposed within and travels as part of mobile computing environment 202.

As illustrated, mobile computing environment 202 is capable of carrying one or more, e.g., a plurality, of passengers 206. In some cases, passengers 206 are capable of moving about within mobile computing environment 202 while in other cases, depending on the particular implementation of mobile computing environment 202, passengers 206 may remain relatively immobile or stationary within mobile computing environment 202. For example, users may move about from one car to another in the case where mobile computing environment 202 is a train or a multi-segment bus or other vehicle including multiple compartments or areas in which passengers 206 may move about (e.g., from one compartment) to another.

In the example of FIG. 2, passengers 206 may have, or be capable of operating, devices 208. In one or more embodiments, one or more or all of devices 208 are personal computing devices such as a smart phone, a wearable computing device (e.g., earbuds or earphones, smart watch, smart glasses), a portable computer such as a laptop or tablet, or other type of computing device that is capable of communicating with IMS 160. For example, one or more of devices 208 may be implemented as an end user device such as EUD 103 of FIG. 1. In some embodiments, passengers 206 may opt into sharing passenger data 214 from their respective devices 208. The passenger data 214 may include, but is not limited to, state data from their respective devices, sensor data generated by their respective devices (e.g., biometric data such as heart rate, heart rate variability, stress levels), explicit feedback (e.g., user responses), user profile data, or other user inputs such as demands 212.

In one or more other embodiments, one or more of devices 208 may be a terminal that is provided by or part of mobile computing environment 202 and that is usable or shared by one or more passengers 206 whether concurrently or at different times. For example, one or more of devices 208 may be a publicly available terminal within mobile computing environment 202 that is capable of receiving user input and/or providing generated content (e.g., text, images, video, and or audio). Examples of such devices may include an entertainment system or terminal in a headrest of a seat in an automobile or airplane, a shared display screen or other electronic signage, etc. In such cases, the devices may be operatively coupled to IMS 160.

Mobile computing environment 202 also includes one or more, e.g., a plurality of, sensors 210. Sensors 210 may be distributed in and around mobile computing environment 202. In one or more embodiments, sensors 210 may include one or more IoT sensors of sensor set 125 described in connection with FIG. 1. In one or more embodiments, sensors 210 may include other types of sensors including, but not limited to, cameras, LiDAR sensors, microphones, temperature sensors (e.g., temperature sensors disposed inside mobile computing environment 202 and/or temperature sensors disposed external to mobile computing environment 202), ambient lighting sensors, motion sensors, precipitation sensors, wind speed sensors, a global positioning system capable of providing geographic location information, accelerometers, gyroscopes, and the like.

Sensors 210 are capable of collecting and outputting a variety of different types of information. For example, sensors 210 are capable of capturing individual and collective information for passengers 206, tracking location (e.g., movement) of passengers 206 within mobile computing environment 202, tracking the location (e.g., movement) of mobile computing environment 202, and/or detecting environmental conditions. The environmental conditions may include interior environmental conditions referring to the interior environment of, or within, mobile computing environment 202 (e.g., temperature, lighting levels) and exterior environmental conditions referring to environmental conditions external to mobile computing environment 202 (e.g., outdoor conditions such as outside temperature, precipitation, wind speed and/or direction, etc.).

In one or more embodiments, devices 208 may include a variety of different sensors. Sensors of devices 208 may include biometric sensors such as pulse sensors, skin temperature sensors, accelerometers, electrodermal activity sensors, blood oxygen level sensors, galvanic skin response sensors, photoplethysmography sensors, and the like capable of generating biometric data for passengers 206. The biometric data may include information such as heart rate, heart rate variability, and the like that may be provided as passenger data 214.

In the example, passengers 206 may submit demands 212 to IMS 160. Each demand may be a particular request for generative content. A demand may be specified as structured data or as free-form data. The demands may be, for example, in text form, speech recognized text, or the like. In one or more embodiments, passengers 206 may submit demands 212 via devices 208 that may be in wired and/or wireless communication with IMS 160. In some embodiments, one or more of demands 212 are “explicit” demands which may be user queries or requests for content directed to IMS 160. In one or more examples, each demand 212 may be considered a particular inference task that requires execution of an AI model to generate the content requested.

In one or more other embodiments, one or more demands may be automatically generated by IMS 160. For example, because a user chooses to share passenger data 214 from their device 208 and/or based on sensor data from sensors 210, IMS 160 may detect that the user is conducting a particular Web search, reading particular content (e.g., a book, a Web page, etc.), listening to particular content, viewing particular audiovisual content (e.g., a video), and/or exhibiting particular biological attributes. In that case, IMS 160 may interpret passenger data 214 willingly shared from the user's device, sensor data, and/or context of mobile computing environment 202 to automatically formulate or generate one or more demands for content that are relevant to the information received. In any case, IMS 160 is capable of generating one or more demands for such content on behalf of one or more passengers 206.

The demands for content, whether automatically generated or not, may be for personalized content for one or more of passengers 206. The demands may be for content of the same or similar variety to that which the user is currently consuming on their device, content about the context of mobile computing environment 202, and/or content pertaining to the context of the mobile computing environment as informed by (e.g., based on) the sensor data.

In the example of FIG. 2, IMS 160 may implement an executable software framework capable of performing the various operations described within this disclosure. In one or more examples, IMS 160 is capable of providing contextualized and/or personalized content to passengers 206 as a service. IMS 160 further is capable of the assignment of inference tasks to AI models 226 and/or offloading inference tasks to other AI models that may be executing in remotely located computing nodes.

In general, IMS 160 is capable of leveraging generative AI and sensor technology to personalize passengers' experiences. Sensors 210, for example, are capable of continuously generating sensor data to facilitate continuous and real-time monitoring and analysis of the sensor data to generate context information specifying metrics/data items such as passenger density, temperature, and ambient lighting levels. The sensor data collected from sensors 210 may be used, at least in part, as inputs to IMS 160. Based on received inputs, IMS 160 is capable of managing dynamic adjustments to onboard services provided to passengers 206 in real time by way of AI models 226. Passengers 206, for example, are able to access a digital interface embedded in devices 208 to obtain real-time information generated by AI models 226 and/or other AI models relating to upcoming stops, estimated arrival times, and/or nearby attractions.

In one or more embodiments, as mobile computing environment 202 becomes crowded during peak hours, IMS 160 is capable of detecting such changes (e.g., an increase in passenger density) and automatically adjust usage and/or availability of AI models 226 and/or balance workloads between onboard content generation, multi-vehicle workload orchestration, and/or offloading workloads to remote computing nodes 220. IMS 160 is capable of using sensor data, passenger data 214, and/or demands 212 specifying on-route information, environmental data, and user personal information to offer personalized recommendations and/or content generation for wellness services available onboard. In case of a clearance security violation promoted by the exchange of sensitive information with a passenger 206 whose clearance level does not meet the requirements, IMS 160 is capable of flagging such a violation, halt the exchange of data, and notify relevant authorities or administrators for further action and investigation.

In one or more embodiments, AI models 226 may be stored locally in computer 101, e.g., in persistent storage 113. With AI models 226, persistent storage 113 may store a model profile for each AI model. Each model profile may specify attributes of the corresponding AI model. The model profile may specify attributes including, but not limited to, a passenger density rating specifying a particular passenger density, one or more ranges of passenger density, and/or a category of passenger density (e.g., low or high). Other examples of attributes that may be specified in the model profiles may include, but are not limited to, a criticality rating (e.g., critical or non-critical), a latency (e.g., an amount of time required for computer 101—a local computing resource—to perform an inference operation), and/or a computing resource requirement indicating an amount of available local computing resources needed to execute the AI model.

AI models 226 may be implemented as any of a variety of known and/or to be developed AI models, whether large or smaller more targeted models. The AI models may be referred to as foundational models. One or more AI models 226 may include one or more large language models (LLMs), Generative Adversarial Networks (GANs), Diffusion Models, Variational Autoencoders (VAEs), Flow models, or the like. Different models may be trained to generate different types of content (e.g., text vs. video vs. images, etc.). For example, an LLM such as ChatGPT may be used to generate text while another AI model such as Sora AI Video Generator may be used to generate video content. IMS 160 is capable of performing on-demand, local inference by executing one or more selected AI models 226.

In the example of FIG. 2, AI models 226 are pre-trained models each capable of generating certain type(s) of content, performing particular actions, controlling particular systems, and/or responding to particular type(s) of demands. In one or more embodiments, each different generative AI model 226, though trained, may be configured once loaded for execution. An example of configuring a generative AI model is tuning the generative AI model by setting and/or changing one or more hyperparameters of the generative AI model once loaded for execution (e.g., where loading includes loading the model or portions thereof into program execution memory of a computing system). In this regard, adaptive systems 232 are capable of not only loading and/or unloading different ones of AI models 226 in response to changing demands, but also configuring and/or re-configuring those AI models 226 that have been loaded for execution (e.g., for performance of an inference task such as generating content).

In some aspects, each parameter may be used to match or correlate with a current context of mobile computing environment 202 to selectively activate and/or deactivate AI models on demand in real time based on current need (e.g., contextual information). For example, in the case of a passenger density rating, an AI model may be trained to perform a set one or more inference tasks that are specific to the attribute (e.g., the value of the attribute). In an example, an AI model having a passenger density rating of high or above a predetermined threshold may be trained to perform a set of one or more inference tasks that generate crowd management information within mobile computing environment 202. In another example, an AI model having a passenger density rating of high or above a predetermined threshold may be trained to perform a set of one or more inference tasks that manage an onboard system of the mobile computing environment 202. Examples of onboard systems may include a lighting system and/or a climate control system of the mobile computing environment 202. In another example, an AI model having a passenger density rating of low or less than or equal to a predetermined threshold may be trained to perform a set of one or more inference tasks that generate passenger and/or passenger-specific content (e.g., content for specific passengers based on demands).

In the example of FIG. 2, for purposes of illustration, mobile computing environment 202 may be in motion and traversing a predetermined or known route 228. Route 228 may have a predetermined or known destination 216. As an illustrative and nonlimiting example, destination 216 may be a particular end point or point of interest (POI) as part of an organized tour, a location specified by one of passengers 206 as part of a request for directions, a stop on a bus or train route, a destination airport, landmark, or the like. There may also be one or more other POIs 218 (e.g., locations, landmarks, structures, etc.) located on, along, or within a predetermined distance of route 228.

FIG. 2 also illustrates that there may be one or more other computing nodes 220 shown as computing nodes 220-1, 220-2, 220-3, and 230 dispersed geographically. That is, computing nodes 220-1, 220-2, 220-3, and 230 are disposed at different locations and are considered remotely located from mobile computing environment 202. Each of computing nodes 220 may be accessed by a communication link, e.g., a wireless communication link such that mobile computing environment 202 and/or user devices 208 therein may communicate with computing nodes 220. Each of computing nodes 220-1, 220-2, and 220-3 further includes a respective Generative Artificial Intelligence Computing System (GAICS) 222-1, 222-2, and 222-3 that may be accessed by establishing a communication link with the respective computing node 220. In the example, computing node 230 may be a cloud computing node (e.g., a data center) that also may include a GAICS.

In one or more embodiments, one or more of computing nodes 220 may be implemented as a remote server such as remote server 104 of FIG. 1. In one or more embodiments, one or more of computing nodes 220 may be implemented as a private cloud such as private cloud 106 of FIG. 1. In one or more embodiments, one or more of computing nodes 220 may be implemented as a public cloud such as public cloud 105 of FIG. 1.

In one or more embodiments, one or more of computing nodes 220 is implemented as a multi-access edge computing (MEC) node. MEC is a European Telecommunications Standards Institute (ETSI)-defined network architecture. The network architecture facilitates the implementation of cloud computing capabilities and an Information Technology (IT) service environment at edge nodes of a cellular and/or other type of network. Accordingly, computing nodes 220 implemented as MEC nodes are capable of providing cloud computing capabilities and may host or execute any of a variety of AI models including generative AI models. As such, each of computing nodes 220 is capable of performing on-demand inference (e.g., performing generative AI tasks or operations) in response to requests/demands received from IMS 160.

As discussed, IMS 160 may be implemented as an executable framework executing on an onboarded, e.g., in vehicle, computing system that is capable of dynamically generating content for passengers 206 based on a set of demands whether from passengers 206, automatically generated, or a combination thereof. Computer 101 and/or IMS 160 may include computing clusters, a repository of base methods to perform the operations described herein and/or foundational models (e.g., generative AI models and/or other AI models). In the example, computer 101 may be embodied as one or more hardware processors (e.g., CPUs and/or GPUs and memory) that are integrated in mobile computing environment 202 and/or as a dedicated computing system in mobile computing environment 202. Such computing hardware, for example, may be part of an infotainment system of mobile computing environment 202 and/or may be integrated in one or more other systems of mobile computing environment 202 (e.g., climate control systems, lighting systems, audio systems, video/visual systems, signage systems, or the like).

IMS 160 is capable of orchestrating the execution of demands 212 for content. In one or more embodiments, IMS 160 is capable of determining the complexity of demands 212 (e.g., inference tasks). In one or more embodiments, complexity is a measure of an amount of computational resources (e.g., number of GPUs, CPUs, required) and time required to perform an inference task (e.g., as specified by a demand) through execution of a particular generative AI model by particular hardware (e.g., computer 101).

In one or more embodiments, IMS 160 is capable of choosing which demands 212 are to be offloaded to a selected computing nodes 220 and/or 230 to compensate for a lack of local resources in IMS 160 while also ensuring that the demand(s) 212 that are offloaded are timely processed so that passengers 206 perceive responses (e.g., the generated content) to be received in real-time or near real-time in relation to issuance of demand(s) 212 and/or in a timely manner.

In one or more embodiments, IMS 160 is capable of controlling which AI models 226 are loaded for execution, e.g., activated. IMS 160 is capable of unloading one or more selected AI models 226 from program execution memory (e.g., deactivating AI models). Accordingly, IMS 160 is capable of activating and/or deactivating one or more AI models 226 based on new or changing context information.

In one or more embodiments, IMS 160 is capable of predicting selected content to be generated, generating the selected content automatically (e.g., either locally or by offloading automatically generated demand(s)), and providing the selected content to a device of at least one user. This may include, for example, generating content for one or more users based on the context information, which may include the distance of mobile computing environment 202 to a POI along route 228, and/or other user data.

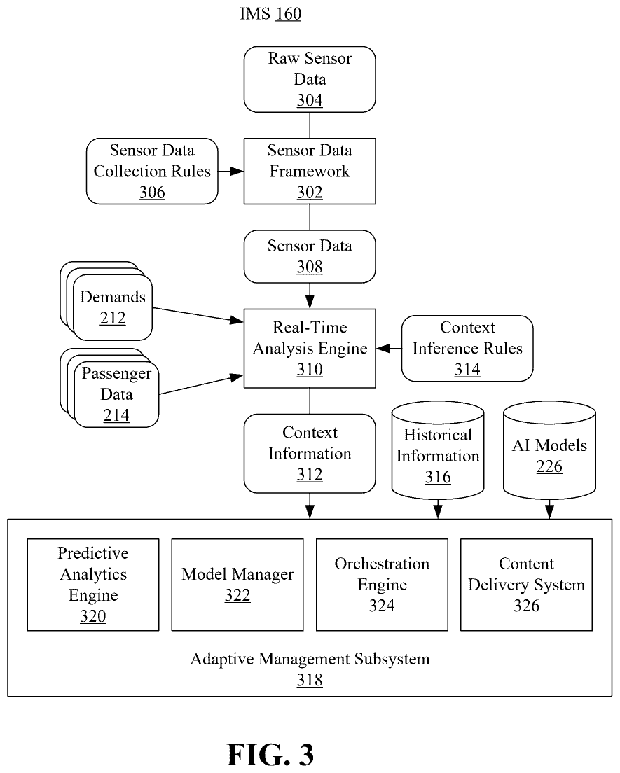

FIG. 3 illustrates an example of IMS 160 in accordance with one or more embodiments of the disclosed technology. In the example, IMS includes a sensor data framework 302 that is capable of pre-processing raw sensor data 304 as output from sensors 210. For example, sensors 210 may not produce data in a uniform way. Some sensors 210 may output binary data while others output JSON data structures, or the like. The type of output from sensors 210 may vary based on the type of sensor and/or sensor manufacturer/provider. In the example, sensor data framework 302 is capable of capturing raw sensor data 304 from sensors 210 and formatting the raw sensor data 304 into a uniform structure such as sensor data 308 that may be consumed or utilized by other subsystems within IMS 160. In the example, sensor data framework 302 is configurable based on sensor data collection rules 306 that define particular pre-processing operations to be performed for different items of raw sensor data 304 from different ones of sensors 210. In one or more examples, sensor data collection rules 306 may specify a frequency of data collection to be performed by sensor data framework 302 to ensure real-time analysis and responsiveness for managing (e.g., activating and/or deactivating) AI models 226. Sensor data framework 302 is capable of outputting sensor data 308, e.g., processed and/or formatted sensor data, to real-time analysis engine 310.

Real-time analysis engine 310 is capable of implementing a rule-based model that may be augmented with one or more machine learning models. Real-time analysis engine 310 is capable of analyzing the data points from the sensor data 308 to determine current conditions, e.g., that are included in, or used to generate, context information 312 for mobile computing environment 202.

In one or more embodiments, real-time analysis engine 310 is capable of extracting conditions specified in sensor data 308 and outputting context information 312. Context information 312 may be provided as a file or other data structure to one or more other subsystems of IMS 160. In one or more examples, the particular data extracted from sensor data 308 and included in context information 312 may be specified or defined by context inference rules 314. In one or more examples, context inference rules 314 may specify other information to be included in context information 312 such as known or predetermined items of information that may include, but are not limited to, a destination, route 228, type of vehicle, public or private vehicle, other characteristics of the vehicle (e.g., number of cars, capacity, etc.), or the like.

Real-time analysis engine 310 is capable of generating contexts, specified as context information 312, in real time. Examples of the type of data that may be included in context information 312 (e.g., a “context”), can include predetermined or known data items and/or data items detected and/or derived from sensor data 308. For example, context information 312 may define a particular purpose (e.g., a goal or objective) of mobile computing environment 202 and/or of passengers 206 in mobile computing environment 202. Context information 312 may indicate that mobile computing environment 202 may be used for a tour (e.g., a tourism tour where mobile computing environment 202 is a tour bus or other vehicle traversing a known, predetermined, or predictable route), that one or more of passengers 206 are going to work or embarking on a trip, etc. In some cases, the context of mobile computing environment 202 may specify a known destination and, as such, have a predictable route. Context information 312 also may specify a particular mode of transportation for mobile computing environment 202 such as driving, walking, bus, or train.

Context information 312 may specify other information that changes over time as may be obtained from sensor data 308. For example, context information 312 may indicate, or specify, a number of passengers 206 in mobile computing environment 202 at any given time (e.g., passenger density that may be expressed as a ratio, percentage or value that specifies the number of passengers detected on mobile computing environment 202 compared to the capacity of mobile computing environment 202). The number of passengers 206 may be determined by detecting the passengers 206 via sensors 210, by each user indicating presence within mobile computing environment 202 (e.g., via ticket and/or device scanning upon entry and/or exit), via image processing of camera sensor data to detect human forms, or via user input to IMS 160. Real-time analysis engine 310 may perform the processing necessary to generate the passenger density data. In some cases, context information 312 may specify a relationship between passengers 206 or between subsets of passengers 206. For example, depending on the context (e.g., business trip, going to work, vacation, etc.) the passengers 206 may not be acquainted, may be colleagues, may be family (e.g., related), etc.

In the example, context information 312 may also include or specify additional information received by real-time analysis engine 310 such as demands 212 and/or passenger data 214. In the example, context information 312 is provided to adaptive management subsystem 318 of IMS 160 with historical information 316. In the example, adaptive management subsystem 318 includes a predictive analytics engine 320, a model manager 322, an orchestration engine 324, and a content delivery system 326. In general, adaptive management subsystem 318 is capable of determining which of AI models 226 are to be activated and/or deactivated at any given time, which, if any, inference tasks may be offloaded from mobile computing environment 202 to one or more other computing nodes 220, 230 and a generative AI model executed therein, and/or select such other computing node 220, 230 and/or a particular generative AI model to be executed and to which an inference task is to be offloaded.

In one or more embodiments, real-time analysis engine 310 is capable of calculating a variety of metrics such as computing resource availability in IMS 160, which AI models 226 are currently loaded for execution in IMS 160, the configuration (e.g., tuning) of AI models 226, mobility patterns of passengers 206, intentionality of collective user intention, variations of collective user behavior, and the computing requirements of demands 212. This information may be included or specified in context information 312.

In one or more embodiments, predictive analytics engine 320 is capable of analyzing real-time data in the form of context information 312, as well as historical information 316, to predict future states and optimize decisions. As an illustrative and non-limiting example, predictive analytics engine 320 may be implemented as a rule-based model that may be augmented with one or more machine learning models. The models may be trained to predict passenger density and/or passenger density trends at future points in time (e.g., at different times and/or at different stopping points along route 228 to preemptively adjust AI model activations.

In another example, predictive analytics engine 320 is capable of predicting network conditions based on past performance of network connections from historical information 316 and real time network congestion data to decide on offloading strategies implemented by orchestration engine 324. For example, predictive analytics engine 320 may generate data, e.g., predicted context information, that may be used by model manager 322 to active and/or deactivate AI models and to determine whether to invoke orchestration engine 324 to offload one or more inference tasks. In another example, predictive analytics engine 320 may perform pattern recognition to detect correlations in large datasets to allow orchestration engine 324 to adapt to new and evolving conditions efficiently and automatically.

In another example, predictive analytics engine 320 may predict network conditions based on past performance (e.g., from historical information 316) that may be used by orchestration engine 324 as part of the decision making performed as part of the offloading strategy. For example, the offloading strategy may initiate offloading of an inference task in cases where network performance is predicted to exceed a predetermined level in terms of latency and/or network congestion. Similarly, the offloading strategy may choose not to offload an inference task in response to a prediction that network performance does not exceed the predetermined level. In another example, predictive analytics engine 320 may perform pattern recognition to detect correlations in large datasets to allow orchestration engine 324 to adapt to new and evolving conditions efficiently and automatically.

Model manager 322 is capable of activating and/or deactivating particular ones of AI models 226 over time based on context information 312. Model manager 322 may be implemented as a rule-based model that may be augmented with one or more machine learning models. Model manager 322 may use real-time data, e.g., context information 312, and/or predefined criteria to optimize resource utilization and service delivery. In the examples described herein, activating an AI model refers to loading the AI model from a data storage device such as a persistent storage 113 into runtime memory (e.g., volatile memory 112 such as RAM) such that the AI model may be executed by processor set 110. Activation also may include configuring the AI model and/or executing the AI model. In one or more embodiments, model manager 322 is also capable of using future context information from predictive analytics engine 320 to make AI model activation and deactivation decisions. In one or more other examples, model manager 322 is capable of using future context information and context information 312 to make AI model activation and deactivation decisions.

In one or more embodiments, model manager 322 is capable of operating across mobile computing environment 202 and remote computing systems (e.g., computing nodes 220 including hybrid cloud facilities such as computing node 230). Depending on real-time passenger data, such as passenger density, ambient conditions, and/or individual health metrics from wearable devices of passengers 206, model manager 322 is capable of selectively activating and/or deactivating different ones of AI models 226. For instance, during peak hours, model manager 322 is capable of prioritizing traffic and crowd management AI models 226. During quieter time periods, e.g., off peak hours, model manager 322 is capable of switching to AI models 226 that are trained to deliver personalized content to passengers 206. This adaptive management by model manager 322 is capable of optimizing local computing resource usage and ensures timely and relevant service delivery for passengers 206.

As another example, in response to detecting that interior temperature of mobile computing environment 202, as determined from sensor data 308, exceeds a threshold temperature, model manager 322 is capable of activating a climate control AI model of AI models 226. In some embodiments, the rule-based models may be implemented using if-then logic that provides straightforward and easily understandable decision pathways. This ensures rapid responses in scenarios where conditions, per context information 312, fall within expected, e.g., predefined, parameters or ranges.

Orchestration engine 324 may be implemented as a rule-based model that may be augmented with one or more machine learning models. In one or more embodiments, orchestration engine 324 is capable of applying the rule-based and/or inference-based workload balancing that adapts to real time data relating to passenger density and environmental conditions to dynamically allocate computational resources within mobile computing environment 202. Orchestration engine 324 is capable of continuously monitoring the workload placed on the computational (e.g., computer) resources of mobile computing environment 202 across tasks such as content generation to offload tasks to computing nodes 220 such as MEC servers and/or computing node 230. During peak hours, for example, or in cases where passenger density increases, orchestration engine 324 is capable of prioritizing certain tasks (and the AI models that perform such tasks) to optimize computer resource allocation in mobile computing environment 202. Orchestration engine 324 is capable of offloading non-critical tasks to remote computer systems to ensure operation and responsiveness of onboard services provided by the onboard computer systems executing AI models 226.

Adaptive management subsystem 318 may include one or more other subsystems therein not illustrated in the example of FIG. 3. For example, adaptive management subsystem 318 may include a rule-based decision model and/or one or more large AI models that are capable of generating recommendations for relevant content and that may coordinate the delivery of relevant content to multi-user mobile environments. In one or more examples, the content recommendation system may be included as part of content delivery system 326.

In one or more embodiments, content delivery system 326 is capable of using sensor data 308 (e.g., context information 312), as generated in real time, and predictive analytics from predictive analytics engine 320 to provide users with timely and relevant information via digital interfaces. The predictive analytics, e.g., predicted context information, generated by predictive analytics engine 320, for example, may specify recommendations for prioritizing and/or adjusting content generation based on factors such as upcoming stops, estimated arrival times, nearby attractions, passenger preferences, current environmental conditions, and/or predicted future passenger density.

Content delivery system 326 is capable of providing demands to different AI models 226 and/or to any AI models executing in remote computing nodes 220 and/or 230. Content delivery system 326 is capable of receiving the content and delivering content to target devices and/or systems, whether the target devices are end-user devices (e.g., personal devices), content delivery devices that are part of an infotainment system of mobile computing environment 202, or other systems of mobile computing environment 202.

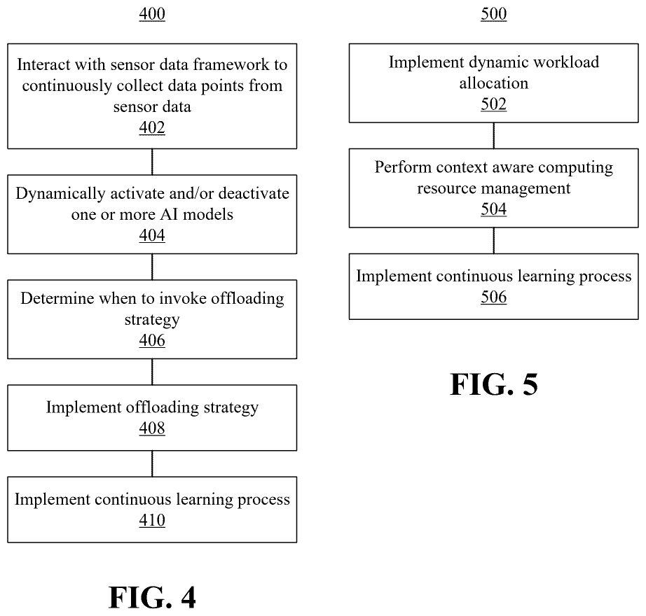

FIG. 4 illustrates a method 400 of AI model deployment in accordance with one or more embodiments of the disclosed technology. Method 400 may be performed by IMS 160. In block 402, real-time analysis engine 310 is capable of interacting with sensor data framework 302 to continuously collect various data points from sensor data 308. Real-time analysis engine 310 is capable of generating context information 312 which specifies current, e.g., real time conditions, in and/or around mobile computing environment 202.

In block 404, model manager 322 is capable of dynamically activating and/or deactivating one or more AI models 226 based on context information 312. In one or more embodiments, model manager 322 is capable of activating and/or deactivating one or more of the AI models 226 based on information specified in context information 312, which may include date, time of day, and/or historical information 316. For example, during one or more times of a day considered to be peak hours based on historical information 316 in terms of passenger density (e.g., when the number of passengers 206 on board mobile computing environment 202 exceeds a threshold passenger density), model manager 322 is capable of selecting particular AI models 226 that are suited or trained to perform particular inference tasks such as, for example, crowd management and/or traffic flow (e.g., models trained for providing upcoming stop information, or other directions for entering and/or exiting the vehicle, etc.). Selected AI models may have an attribute in their respective model profiles indicating “high passenger density.” Model manager 322 is capable of activating those AI models 226 that have been selected. Non-selected AI models 226 suited for off-peak hours, e.g., those AI models having an attribute in their respective model profiles specifying “low passenger density,” may be deactivated.

Accordingly, during times of day considered off-peak hours in terms of passenger density (e.g., when passenger density as measured from sensor data is considered low such as being less than or equal to the predetermined threshold passenger density), model manager 322 is capable of activating AI models that are suited or trained to deliver personalized content to passengers 206. Model manager 322 is capable of deactivating models that are suited for peak hours during off-peak hours. Personalized content may include, for example, wellness recommendations that may be generated based, at least in part, on passenger provided biometric data.

In one or more embodiments, the particular type of personalized content that is to be delivered to passengers 206 may be prioritized based on various criteria such as biometric information (e.g., passenger data 214) received from passengers 206 and/or POIs 218 along route 228 traversed by mobile computing environment 202. In some cases, the personalized content generated may be tailored entertainment options or suggested wellness activities determined based on individual passenger provided or shared data. The personalized content may be content generated by one or more generative AI models including, but not limited to, AI models 226.

In block 406, model manager 322 is capable of determining whether or when to invoke an offloading strategy. The offloading strategy is a function implemented by orchestration engine 324. The offloading strategy is capable of selecting a particular set of inference tasks and offloading the selected inference tasks to a one or more of computing nodes 220 and/or 230. For example, rather than activate and/or use a selected AI model 226, a same and/or similar AI model as the local AI model may be invoked in a remotely located computing node to provide the same or substantially similar functionality as the AI model 226 that is local. The ability to offload inference tasks from the local computing resources, e.g., computer 101, of mobile computing environment 202 to a remotely located computing node 220 and/or 230 allows computing resources of mobile computing environment 202 to be conserved or used for other purposes.

In one or more embodiments, the rule-based inference model and/or machine learning model(s) of orchestration engine 324 may be trained so that any inference tasks considered to have a priority exceeding a threshold priority may be performed using one or more of AI models 226 (e.g., local AI models and local computing resources). This prioritization ensures faster response times for obtaining results for high priority inference tasks. Further, the local AI models 226 may be dynamically activated and/or deactivated on demand by model manager 322.

In one or more embodiments, the rule-based inference model and/or machine learning model(s) of orchestration engine 324 may be trained to offload complex and/or resource intensive inference tasks from mobile computing environment 202 to computing nodes 220 and/or 230. In another example, orchestration engine 324 may be trained to offload complex and/or resource intensive inference tasks from mobile computing environment 202 to computing nodes 220 and/or 230 in response to determining that the inference tasks are not prioritized (e.g., offloading a complex inference task to a remote computing node that would otherwise be suspended as being an off-peak (on-peak) function when it is determined to be on-peak (off-peak) time. As noted, computing nodes 220 may include one or more regional 5G-MEC nodes configured to provide cloud computing resources and remote inferencing. The collaboration between mobile computing environment 202 and computing nodes 220 and/or 230 by way of orchestration engine 324 ensures that even during peak loads, IMS 160 is capable of providing high performance and responsiveness to passengers 206.

In one or more embodiments, orchestration engine 324 is capable of providing fast and deterministic responses to selected well-defined contexts. As an example, orchestration engine 324 may include rules that make decisions about inference task allocation. An example rule-based model implemented by orchestration engine 324 may include rules for handling changing passenger density over time. For purposes of illustration, passenger density as determined from sensor data 308 and specified within context information 312 is referred to herein as “sensor-based passenger density.” For example, in response to sensor-based passenger density exceeding a threshold passenger density, one or more high complexity tasks may be offloaded from mobile computing environment 202 to a computing node 220 and/or 230.

In block 408, orchestration engine 324 is capable of implementing the offloading strategy. Orchestration engine 324 may implement the offloading strategy in response to model manager 322 invoking such function. In one or more other examples, orchestration engine 324 is capable of invoking the strategy automatically in response to detecting the workload of computer 101 exceeding a predetermined threshold workload and/or based on a future expected workload of computer 101 based on predicted context information from predictive analytics engine 320.

For example, model manager 322 may invoke orchestration engine 324 in order to implement the offloading strategy. The offloading strategy as performed by orchestration engine 324 is capable of selecting which inference tasks will be executed locally using computing resources of mobile computing environment 202 and AI models 226 and which inference tasks will be offloaded to one or more computing nodes 220. In selecting whether to offload a given inference task, the offloading strategy executed by orchestration engine 324 may consider the following information:

Task Complexity: Orchestration engine 324 is capable of prioritizing the execution of simple (e.g., tasks having a complexity rating below a threshold complexity) locally. In one or more embodiments, tasks may be rated in terms of complexity based on how long the task will require to execute, e.g., the task latency. A latency above a particular threshold latency will be rated as a complex task or be assigned a complexity rating above a complexity threshold. A task that has a latency below the latency threshold will be considered a non-complex or simple task and be assigned a complexity rating below the threshold complexity. In some embodiments, the latency of a task may be used as the complexity rating. Accordingly, in response orchestration engine 324 determining that a given inference task is complex, orchestration engine 324 may offload the inference task.

Resource Availability: Orchestration engine 324 is capable of determining the current load on local computing resources of mobile computing environment 202 and deciding whether to offload tasks to computing nodes 220 to prevent exhaustion or overburdening the local computing resources of mobile computing environment 202. In response to determining that the workload of computer 101 exceeds the threshold workload or will exceed the threshold workload if a selected inference task is performed locally, orchestration engine 324 is capable of offloading the selected inference task.

Network Conditions: Orchestration engine 324 is capable of determining real-time network conditions of network connections to computing nodes 220 and/or 230 to ensure that any tasks offloaded to a computing node 220 and/or 230 may be performed without undue delays caused by poor network conditions. For example, orchestration engine 324 may determine whether the latency of a given network connection is above a threshold latency and, if so, not offload a task to a computing node 220 and/or 230 over such a connection or not at all. Conversely, if a network connection has a latency that does not exceed the threshold latency, orchestration engine 324 may consider offloading a task to the computing node 220 and/or 230 over the connection.

Security and Compliance: Orchestration engine 324 is capable of ensuring data privacy and security by implementing strict access controls and real-time monitoring to detect and respond to security breaches or violations promptly. In one or more examples, any inference tasks generated using personal and/or biometric information of a passenger may be maintained or performed locally so as not to share such data with other external computing nodes.

In block 410, model manager 322 and/or orchestration engine 324 may implement continuous learning and improvement. For example, model manager 322 and/or orchestration engine 324 are capable of implementing algorithms that implement feedback loops that process feedback data received from passengers 206, sensor data, network condition data, and the like to improve performance of when to invoke the offloading strategy provided by orchestration engine 324 over time and/or to improve the offloading strategy itself as performed by orchestration engine 324. For example, model manager 322 and/or orchestration engine orchestration engine 324 may receive passenger feedback on the services provided to identify areas for improvement, may refine and/or update rule-based and/or AI models based on collected data to ensure that the models remain relevant and effective despite changing conditions, and may monitor key performance indicators (KPIs) to determine the effectiveness of model manager 322 and/or orchestration engine 324 in terms of the particular contexts in which to invoke orchestration engine 324.

FIG. 5 illustrates a method 500 of workload balancing in accordance with one or more embodiments of the disclosed technology. Method 500 may be performed by IMS 160 and illustrates a more detailed technique for activating and/or deactivating different AI models 226 over time.

In block 502, model manager 322 is capable of implementing dynamic workload allocation. For example, model manager 322 is capable of categorizing inference tasks. Model manager 322 is capable of categorizing inference tasks based on a variety of different criteria. For example, model manager 322 may categorize inference tasks into a first group corresponding to high-priority or essential inference tasks and a second group corresponding to low-priority or non-critical inference tasks. In one or more other embodiments, model manager 322 may categorize inference tasks based on complexity which may be specified by the computational requirements and/or compute time needed to perform the inference task. For example, model manager 322 is capable of allocating computational resources to inference tasks categorized as high-priority (e.g., activating AI models 226 needed to perform high-priority inference tasks). Inference tasks for real-time content generation may be considered lower priority while inference tasks for passenger information updates may be considered higher priority during peak or high-demand time periods. In cases where local computing resources are insufficient to meet current demand, model manager 322 may invoke orchestration engine 324 to implement the offloading strategy. In such cases, rather than deactivating one or more AI models 226 and not providing any substitute inferencing capability, the offloading allows for offloading of inference tasks that would otherwise not be performed due to computing resource constraints. For example, orchestration engine 324 is capable of offloading non-critical inference tasks to computing nodes 220 and/or 230 during peak hours, e.g., during time periods in which passenger density exceeds or is predicted to exceed the threshold passenger density.

In block 504, model manager 322 is capable of performing context-aware resource management. Model manager 322 may receive context information 312 in real time, where context information 312 provides a comprehensive understanding of current conditions within mobile computing environment 202. Based on context information 312, model manager 322 is capable of dynamically adjusting, based on any predictions generated by predictive analytics engine 320, computing resource allocation in real time by through selective activation and/or deactivation of particular AI models 226. The allocation of computing resources may be performed using rule-based inference models for those cases that have definitive rules with respect to current, real time context information 312.

Model manager 322 also is capable of allocating computing resources, e.g., activating and/or deactivating particular AI models 226, based on predictions of future trends in particular metrics such as passenger density as generated by predictive analytics engine 320. In one or more embodiments, the use of the machine learning models may be used to change or overrule a decision as to allocation of computing resources initially generated from the rule-based inference models. The machine learning models of model manager 322, for example, may receive predictions from predictive analytics engine 320 for workload patterns and passenger behavior under varying conditions to choose which AI models 226 to active and/or deactivate at any given time. Accordingly, model manager 322 is capable of preemptively adjusting computing resource allocation to manage anticipated spikes in demand.

For purposes of illustration, the resource management performed by model manager 322 may implement decisions such as the following:

High Passenger Density: During time periods in which high passenger density is detected, e.g., a sensor-based passenger density exceeds a threshold passenger density, model manager 322 is capable of prioritizing AI models 226 that are capable of performing crowd management inference tasks. During time periods during which sensor-based passenger density is less than or equal to the threshold passenger density, model manager 322 is capable of prioritizing AI models 226 that are capable of performing real-time content delivery inference tasks to passengers 206.

Environmental Changes: Model manager 322 is capable of activating and/or deactivating AI models 226 that are capable of adjusting climate control systems of mobile computing environment 202 (e.g., temperature regulation) based on context information 312.

Health Metrics: Model manager 322 is capable of allocating computing resources to AI models 226 that are capable of generating wellness recommendations to passengers 206. In one or more embodiments, model manager 322 is capable of activating such AI models in response to detecting stress levels or health anomalies in passengers 206 based on biometric data voluntarily provided by passengers 206 and included in the sensor data previously described. Such anomalies may be determined by comparing biometric data (e.g., heart rate, heart rate variability, and/or any of the various biometric data items disclosed herein) with baseline measures of the biometric data whether provided from the user's device or obtained from another data source such as averages determined from other users and/or passengers.

Accordingly, model manager 322, is capable of activating and/or deactivating particular ones of AI models 226 over time. Further, as noted, model manager 322 may invoke orchestration engine 324 in order to offload complex and/or resource-intensive inference tasks to computing nodes 220 and/or 230 to ensure that that local computing resources are not overwhelmed during peak periods and that the computing resources within mobile computing environment 202 remain responsive.

In block 506, model manager 322 and/or orchestration engine 324 are capable of implementing a continuous learning process as previously described.

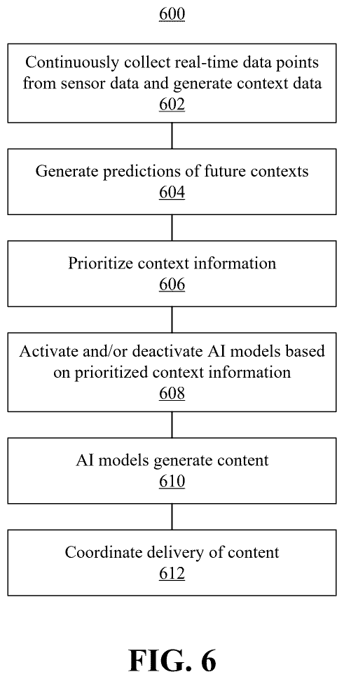

FIG. 6 illustrates a method 600 of context aware content delivery in accordance with one or more embodiments of the disclosed technology. Method 600 may be performed by IMS 160. In block 602, real-time analysis engine 310 is capable of interacting with sensor data framework 302 to continuously collect real-time data points from sensor data 308 such as passenger density, environmental conditions, and individual health metrics of passengers 206. Real-time analysis engine 310 is capable of analyzing sensor data 308 along with other data such as demands 212 and/or passenger data 214 to generate context information 312. In block 604, predictive analytics engine 320 is capable of generating predictions context information specifying predictions of future contexts of mobile computing environment 202 based on context information 312 and historical information 316. The analysis performed by real-time analysis engine 310 and predictive analytics engine 320 may be used as the basis for content generation and delivery decisions.

In block 606, model manager 322 is capable of identifying the most relevant context information from context information 312 (e.g., current context information) and from predicted context information. For example, model manager 322 is capable of prioritizing, e.g., ordering, different items of context information. As an example, model manager 322 may prioritize upcoming stops along route 228, estimated arrival times at the upcoming stops, nearby attractions (e.g., POIs), passenger preferences, and/or current environmental conditions (e.g., inside mobile computing environment 202 and external to mobile computing environment 202). The prioritizing may be performed based on whether, based on time and/or date, peak hours are occurring (e.g., passenger density) and/or are predicted, for example.

In block 608, model manager 322 is capable of activating and/or deactivating AI models 226 based on the prioritized context information. For example, model manager 322 is capable of activating AI models 226 that are to be used for performing inference tasks based on the most highly prioritized context information while deactivating AI models 226 that are used for performing inference tasks corresponding to context information that is not prioritized.

In block 610, selected ones of AI models 226 (e.g., local AI models) and any remotely located AI models executing in computing nodes 220 may generate content. In block 612, content delivery system 326 is capable of coordinating delivery of generated content to passengers 206. The coordination includes directing generated content to particular digital interfaces such as personal devices of some passengers for personalized content, public displays (e.g., those providing signage) of mobile computing environment 202 for other non-personalized content.

As discussed, content generation and content delivery may be updated in real time based on changing context for mobile computing environment 202. For example, as passenger density changes over time and/or other environmental conditions change over time, the particular tasks considered to be high priority and/or the particular AI models 226 used to perform the inference tasks may change. The inventive arrangements ensure that high-priority information is prominently displayed while less critical information is made available as needed based on the current and/or predicted context of mobile computing environment 202.

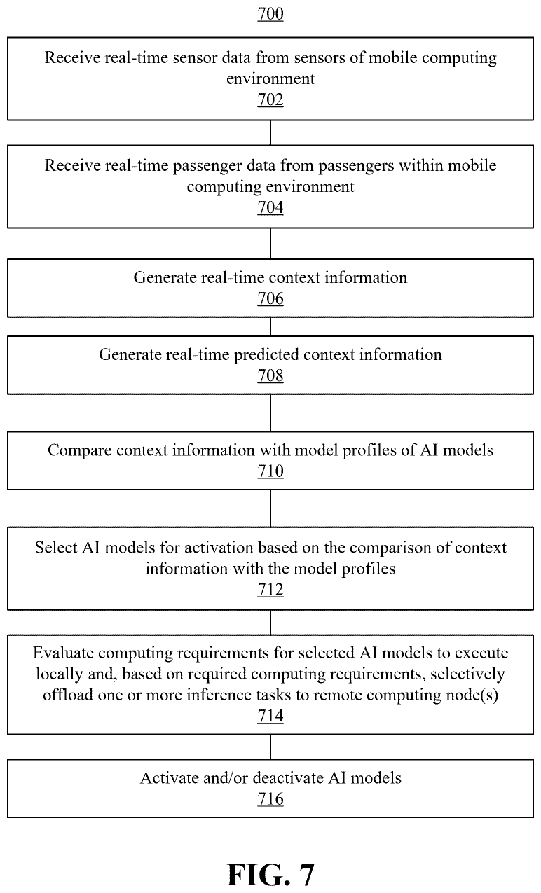

FIG. 7 illustrates an example method 700 of operation for IMS 160 in accordance with one or more embodiments of the disclosed technology. Method 700 may begin in a state with mobile computing environment 202 operating as a multi-passenger vehicle that includes local computing resources such as one or more interconnected computers 101 storing AI models 226. Further, mobile computing environment 202 may be in motion or traversing a route 228. In addition, a model profile is stored for each of AI models 226 that specifies one or more attributes of the corresponding AI model.

In block 702, IMS 160 is capable of receiving real-time sensor data from sensors 210 of mobile computing environment 202. For example, raw sensor data 304 may be received from sensors 210 in real time and preprocessed by sensor data framework 302 to generate sensor data 308 based on sensor data collection rules 306.

In block 704, IMS 160 is capable of receiving real-time passenger data from passengers 206 within mobile computing environment 202. In the example, real-time analysis engine 310 is capable of receiving passenger data 214 in real time.

In block 706, IMS 160 is capable of generating real-time context information. Real-time analysis engine 310 is capable of generating context information 312 in real time from sensor data 308 and from passenger data 214. In one or more examples, real-time analysis engine 310 is capable of generating context information 312 based on context inference rules 314.

In block 708, IMS 160 may optionally generate real-time predicted context information. For example, predictive analytics engine 320 is capable of predicting future context information based on context information 312 and historical information 316.

In block 710, IMS 160 is capable of comparing context information 312, and optionally predicted context information, with the model profiles of AI models 226. For example, model manager 322 is capable of comparing context information 312 and/or predicted context information with particular attributes of the model profiles to determine which of AI models 226 match, or most closely match, the current context information 312. In general, model manager 322 is capable of activating those of AI models 226 that match or correspond to the current context and deactivate those of AI models 226 that do not.

In one or more embodiments, each model profile may specify a passenger density rating for the corresponding machine learning model that indicates the particular passenger density in which the AI model should be used. Similarly, context information 312 may specify a particular passenger density (e.g., a sensor-based passenger density). Accordingly, in one or more examples, model manager 322 is capable of comparing the passenger density rating from the model profiles with the sensor-based passenger density specified by context information 312 and select those AI models of AI models 226 having a passenger density rating that matches the current passenger density of mobile computing environment 202.

In one or more embodiments, IMS 160 is capable of prioritizing AI models 226 based on attributes of the model profiles given the context information 312 and optionally the predicted context information. For example, based on the date and/or the time of the day, model manager 322 may prioritize different ones of AI models 226 for activation. Those AI models that perform certain tasks deemed important or critical during time periods considered peak hours (e.g., where passenger density exceeds a passenger density threshold or is expected to exceed the passenger density threshold) may be selected for activation. Such AI models may include those with attributes indicating a capability of performing inference tasks for crowd management, personalized content delivery, and the like. AI models suited for crowd management inference tasks may be prioritized during peak time periods while AI models suited for personal content delivery inference tasks are prioritized during off-peak time periods.

In block 712, IMS 160 is capable of selecting one or more of AI models 226 for activation based on the comparisons. Model manager 322 is capable of performing the comparisons to determine which of AI models 226 match, or most closely match, context information 312 and/or predicted context information and selecting one or more of AI models 226 that match, or most closely match, context information 312 and/or the predicted context information. Those AI models of AI models 226 that do not match are referred to as non-selected AI models.

In block 714, IMS 160 may optionally evaluate computing requirements for selected AI models to execute locally and, based on required computing requirements, selectively initiate the offloading strategy to offload one or more inference tasks to remote computing nodes. In cases where the computing resources required to execute each of the selected AI models 226 from block 712 are insufficient, model manager 322 may invoke orchestration engine 324 to select one or more of the AI models 226 as selected to be offloaded to a remote computing node such as one or more of computing nodes 220 and/or 230.

In block 716, IMS 160 is capable of dynamically activating and/or deactivating one or more of the plurality of AI models 226. For example, model manager 322 is capable of activating any of the selected AI models not already activated, leave any of the AI models already activated as activated, and deactivate any AI models that were considered non-selected AI models.

In one or more embodiments, individual AI models of AI models 226 that have a passenger density rating exceeding a threshold passenger density may be trained to perform a first set of one or more tasks assigned priorities above a threshold priority. Correspondingly, AI models of AI models 226 that have a passenger density rating at or below the threshold passenger density may be trained to perform a second set of one or more tasks having priorities less than or equal to the threshold priority.

In one or more embodiments, model manager 322 is capable of activating at least a first AI model of the plurality of AI models having a passenger density rating specified in the model profile that matches the sensor-based passenger density. In addition, model manager 322 is capable of deactivating at least a second AI model of the plurality of AI models having a passenger density rating specified in the model profile that does not match the sensor-based passenger density.

For example, AI models with passenger density ratings above a threshold passenger density may be trained to perform inference tasks that generate crowd management information within mobile computing environment 202. In another example, AI models with passenger density ratings above a threshold passenger density may be trained to perform inference tasks that control an onboard lighting system of mobile computing environment 202. In another example, AI models with passenger density ratings above a threshold passenger density may be trained to perform inference tasks that control an onboard climate control system of the mobile computing environment 202. By comparison, AI models with passenger density ratings less than or equal to the threshold passenger density may be trained to perform inference tasks that generate personalized content for one or more passengers of mobile computing environment 202.

In one or more embodiments, model manager 322 is capable of activating at least a first AI model of the plurality of AI models having a passenger density rating specified in the model profile that matches the sensor-based passenger density and offloading at least a second AI model of the plurality of AI models having a passenger density rating specified by the model profile that does not match the sensor-based passenger density to a remote computing node.

In some cases, the offloading is performed responsive to detecting that a network latency between the mobile computing environment and the remote computing node is below a threshold network latency. In some cases, the offloading is performed responsive to determining that a complexity metric specified by the model profile of the at least a second AI model exceeds a threshold complexity.

In another example, a selected AI model that is activated may have a passenger density rating exceeding a threshold passenger density. In that case, a different AI model that is active may be offloaded to from mobile computing environment 202 to a remote computing node. In one example, the offloading may be performed by orchestration engine 324 in response to detecting that the sensor-based passenger density exceeds the threshold passenger density and that a complexity metric of the different AI model exceeds a threshold complexity. In another example, the offloading may be performed in response to detecting that the sensor-based passenger density exceeds the threshold passenger density and that the different AI model has a passenger density rating that is less than or equal to the threshold passenger density. In still another example, the offloading is performed in response to detecting that a network latency between mobile computing environment 202 and the remote computing node 220 or 222 is below a threshold network latency.

The terminology used herein is for the purpose of describing particular embodiments only and is not intended to be limiting. Notwithstanding, several definitions that apply throughout this document now will be presented.

As defined herein, the terms “at least one,” “one or more,” and “and/or,” are open-ended expressions that are both conjunctive and disjunctive in operation unless explicitly stated otherwise. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without intervention from a human being. The term “user” refers to a human being. A passenger is an example of a user.

As defined herein, the terms “includes,” “including,” “comprises,” and/or “comprising,” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if [a stated condition or event] is detected” may be construed to mean “upon determining” or “in response to determining” or “upon detecting [the stated condition or event]” or “in response to detecting [the stated condition or event]” or “responsive to detecting [the stated condition or event]” depending on the context.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “hardware processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller. Processor set 110 is an example of a hardware processor. A hardware processor is an example of computer hardware.

As defined herein, the term “real time” means a level of processing responsiveness that a user or system senses as sufficiently immediate for a particular process or determination to be made, or that enables the processor to keep up with some external process.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

The terms first, second, etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving sensor data from a plurality of sensors in a mobile computing environment and passenger data from a plurality of passenger devices within the mobile computing environment;
generating context information from the sensor data and the passenger data;
storing a plurality of artificial intelligence (AI) models locally within the mobile computing environment, each AI model having a model profile specifying attributes of the AI model;
comparing the context information with the model profiles of the AI models; and
dynamically activating and deactivating different ones of the plurality of AI models for performing inference tasks in a local computing system within the mobile computing environment in real time based on matching the context information with the model profiles.

2. The method of claim 1, wherein the sensor data includes a sensor-based passenger density that is matched to passenger density ratings of the plurality of AI models.

3. The method of claim 2, wherein each AI model of the plurality of AI models having a passenger density rating exceeding a threshold passenger density is trained to perform a first set of one or more inference tasks; and
wherein each AI model of the plurality of AI models having a passenger density rating at or below the threshold passenger density is trained to perform a second set of one or more inference tasks.

4. The method of claim 3, wherein the first set of one or more inference tasks includes generating crowd management information within the mobile computing environment.

5. The method of claim 3, wherein the first set of one or more inference tasks includes managing an onboard lighting system of the mobile computing environment.

6. The method of claim 3, wherein the first set of one or more inference tasks includes managing an onboard climate control system of the mobile computing environment.

7. The method of claim 2, further comprising:
activating at least a first AI model of the plurality of AI models having a passenger density rating specified in the model profile that matches the sensor-based passenger density; and
deactivating at least a second AI model of the plurality of AI models having a passenger density rating specified in the model profile that does not match the sensor-based passenger density.

8. The method of claim 2, further comprising:
activating at least a first AI model of the plurality of AI models having a passenger density rating specified in the model profile that matches the sensor-based passenger density; and
offloading at least a second AI model of the plurality of AI models having a passenger density rating specified by the model profile that does not match the sensor-based passenger density to a remote computing node.

9. The method of claim 8, wherein the offloading is performed responsive to detecting that a network latency between the mobile computing environment and the remote computing node is below a threshold network latency.

10. The method of claim 8, wherein the offloading is performed responsive to determining that a complexity metric specified by the model profile of the at least a second AI model exceeds a threshold complexity.

11. A computer system, comprising:
a processor set;
one or more computer-readable storage media; and
program instructions stored on the one or more computer-readable storage media to cause the processor set to perform operations comprising:
receiving sensor data from a plurality of sensors in a mobile computing environment and passenger data from a plurality of passenger devices within the mobile computing environment;
generating context information from the sensor data and the passenger data;
storing a plurality of artificial intelligence (AI) models locally within the mobile computing environment, each AI model having a model profile specifying attributes of the AI model;
comparing the context information with the model profiles of the AI models; and
dynamically activating and deactivating different ones of the plurality of AI models for performing inference tasks in a local computing system within the mobile computing environment in real time based on matching the context information with the model profiles.

12. The computer system of claim 11, wherein the sensor data includes a sensor-based passenger density that is matched to passenger density ratings of the plurality of AI models.

13. The computer system of claim 12, wherein each AI model of the plurality of AI models having a passenger density rating exceeding a threshold passenger density is trained to perform a first set of one or more inference tasks; and
wherein each AI model of the plurality of AI models having a passenger density rating at or below the threshold passenger density is trained to perform a second set of one or more inference tasks.

14. The computer system of claim 13, wherein the first set of one or more inference tasks includes generating crowd management information within the mobile computing environment.

15. The computer system of claim 13, wherein the first set of one or more inference tasks includes managing an onboard lighting system of the mobile computing environment.

16. The computer system of claim 13, wherein the first set of one or more inference tasks includes managing an onboard climate control system of the mobile computing environment.

17. The computer system of claim 12, wherein the operations further comprise:
activating at least a first AI model of the plurality of AI models having a passenger density rating specified in the model profile that matches the sensor-based passenger density; and
deactivating at least a second AI model of the plurality of AI models having a passenger density rating specified in the model profile that does not match the sensor-based passenger density.

18. The computer system of claim 12, wherein the operations further comprise:
activating at least a first AI model of the plurality of AI models having a passenger density rating specified in the model profile that matches the sensor-based passenger density; and
offloading at least a second AI model of the plurality of AI models having a passenger density rating specified by the model profile that does not match the sensor-based passenger density to a remote computing node.

19. The computer system of claim 18, wherein the offloading is performed responsive to detecting that a network latency between the mobile computing environment and the remote computing node is below a threshold network latency.

20. A computer program product comprising:
one or more computer-readable storage media; and
program instructions stored on the one or more computer-readable storage media to perform operations comprising:
receiving sensor data from a plurality of sensors in a mobile computing environment and passenger data from a plurality of passenger devices within the mobile computing environment;
generating context information from the sensor data and the passenger data;
storing a plurality of artificial intelligence (AI) models locally within the mobile computing environment, each AI model having a model profile specifying attributes of the AI model;
comparing the context information with the model profiles of the AI models; and
dynamically activating and deactivating different ones of the plurality of AI models for performing inference tasks in a local computing system within the mobile computing environment in real time based on matching the context information with the model profiles.
